(19) United States
(12) Patent Application Publication
(10) Pub. No.: US 2026/0356111 A1
(43) Pub. Date: Nov. 12, 2026

(54) SHEET STACKING APPARATUS AND IMAGE FORMING APPARATUS

(71) Applicant: CANON KABUSHIKI KAISHA, Tokyo (JP)

(72) Inventor: SHIGEO HONGU, Ibaraki (JP)

(21) Appl. No.: 19/669,454

(22) Filed: May 6, 2026

(30) Foreign Application Priority Data
May 12, 2025 (JP) 2025-079277

(51) Int. Cl. B41J 13/10; B41J 11/00; B41J 29/13; E05B 47/00

(52) U.S. Cl. CPC B41J 13/106; B41J 11/006; B41J 29/13; E05B 47/0004; E05B 2047/0017

(57) ABSTRACT

An image forming apparatus includes an image forming unit, a first stacking portion configured to stack a sheet, a conveyance guide configured to be openable and closable, a first locking unit configured to lock the conveyance guide, a front door configured to be closable at a closing position and be openable at an opening position where the front door is open to expose the first stacking portion and the conveyance guide, a second locking unit configured to lock the front door, and a control unit, wherein, in a case where a sheet is conveyed to the first stacking portion, the control unit prohibits the front door from being opened, and wherein, in a case where a sheet is conveyed to a second stacking portion after passing through the conveyance guide, the control unit allows the front door to be opened, and prohibits the conveyance guide from being opened.

### BACKGROUND

### Field of the Technology

The present disclosure relates to a sheet stacking apparatus for stacking sheets and an image forming apparatus.

### Description of the Related Art

Conventionally, a sheet stacking apparatus that aligns and stacks sheets on which images are formed by an image forming apparatus has been provided.

In order to clear a paper jam, a sheet stacking apparatus described in Japanese Patent Laid-Open No. 2025-063419 includes a conveyance guide openable and closable relative to a conveyance path.

However, there is a risk of a sheet conveyance failure in a case where the conveyance guide is opened while a job is being executed.

### SUMMARY

The present disclosure is directed to a sheet stacking apparatus and an image forming apparatus capable of preventing occurrence of a conveyance failure while a job is being executed.

According to some embodiments of the present disclosure, an image forming apparatus includes an image forming unit configured to form an image on a sheet, a first stacking portion configured to stack a sheet on which an image is formed by the image forming unit, a conveyance guide configured to form a part of a conveyance path through which a sheet is conveyed, the conveyance guide being openable and closable relative to the conveyance path, a first locking unit configured to lock the conveyance guide to prohibit the conveyance guide from being opened, a front door configured to constitute an exterior front face of the image forming apparatus, the front door being closable at a closing position where the front door is closed and being openable at an opening position where the front door is open to expose the first stacking portion and the conveyance guide, a second locking unit configured to lock the front door to prohibit the front door from being opened, and a control unit configured to control the first locking unit and the second locking unit, wherein, in a case where a sheet is conveyed to the first stacking portion, the control unit prohibits the front door from being opened by controlling the second locking unit, and wherein, in a case where a sheet is conveyed to a second stacking portion different from the first stacking portion after passing through the conveyance guide, the control unit allows the front door to be opened by controlling the second locking unit, and prohibits the conveyance guide from being opened by controlling the first locking unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram schematically illustrating a configuration of an image forming apparatus according to the present embodiment.

FIG. 2 is a block diagram schematically illustrating control hardware of the image forming apparatus according to the present embodiment.

FIG. 3 is a diagram schematically illustrating a discharge-stacking module according to the present embodiment.

FIGS. 4A-4C are diagrams schematically illustrating a door and a conveyance guide according to the present embodiment.

FIGS. 5A and 5B are diagrams schematically illustrating a locking mechanism according to the present embodiment.

FIG. 6 is a table illustrating a relationship in a combination of a system state and a locked state according to the present embodiment.

FIG. 7 is a flowchart illustrating processing for executing locking control of a front door and a conveyance guide according to the present embodiment.

FIG. 8 is a diagram illustrating a perspective view of the conveyance guide.

### DESCRIPTION OF THE EMBODIMENTS

Hereinafter, various exemplary embodiments, features, and aspects of the present disclosure are described with reference to the appended drawings. The below-described embodiments are not intended to limit the present disclosure according to the scope of the appended claims. Further, not all of the combinations of features described in the present embodiments may be used as the solutions of the present disclosure.

### Configuration of Image Forming Apparatus

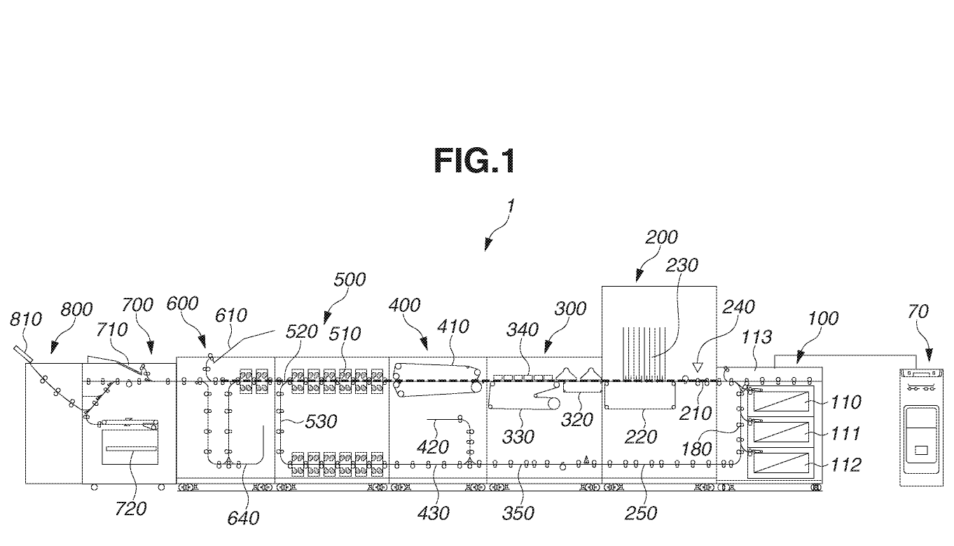

Hereinafter, an image forming apparatus 1 is described with reference to FIG. 1. FIG. 1 is a cross-sectional diagram of the image forming apparatus 1. The image forming apparatus 1 is an ink jet type recording apparatus (ink jet recording apparatus) which forms an ink image on a sheet as a recording medium. However, the image forming apparatus 1 is not limited to the ink jet recording apparatus, and can be an electrophotographic image forming apparatus which forms a toner image on a sheet. The image forming apparatus 1 is a sheet-fed ink jet recording apparatus which forms an ink image (image) on a sheet by using two liquids, i.e., a reaction liquid and an ink.

The image forming apparatus 1 includes a feeding module 100, a printing module 200, a drying module 300, a fixing module 400, a cooling module 500, a reversing module 600, a discharge-stacking module 700, and a discharge option unit 800. A sheet of paper (cut sheet) fed from the feeding module 100 is conveyed along a conveyance path, processed by respective modules, and discharged to the discharge-stacking module 700.

The feeding module 100 includes three containers 110, 111, and 112 which respectively contain a plurality of sheets. The containers 110, 111, and 112 are drawable toward a front side of the feeding module 100. Sheets contained in each of the containers 110, 111, and 112 are individually fed by a separation belt (not illustrated) and a conveyance roller (not illustrated) arranged with respect to each of the containers 110, 111, and 112, and conveyed to the printing module 200. In addition, the number of containers 110, 111, and 112 is not limited to three, and can be one, two, or four or more. Further, the feeding module 100 includes a discharge port 113 as an evacuation destination of erroneous sheets, such as sheets conveyed in an overlapping state, which cannot be used for products. In addition, the image forming apparatus 1 may include a plurality of feeding modules 100 continuously connected to each other.

The printing module 200 includes a pre-imaging registration correction unit 210, a printing belt unit 220, and a recording unit (image forming unit) 230. A skew and a position of the sheet conveyed from the feeding module 100 are corrected by the pre-imaging registration correction unit 210, and the sheet is conveyed to the printing belt unit 220. The recording unit 230 is arranged at a position facing the printing belt unit 220 across the conveyance path. The recording unit 230 is an image forming unit which forms an image on a conveyed sheet by executing recording (printing) processing on the sheet from an upper side through recording heads. The sheet is sucked and conveyed by the printing belt unit 220, so that clearance between the sheet and the recording heads is ensured. The printing module 200 includes an optical sensor 240 for detecting a folded corner and floating of the sheet. In a case where a folded corner or floating of the sheet is detected by the optical sensor 240, the recording unit 230 is evacuated so that the sheet is prevented from making contact with the recording unit 230.

A plurality of recording heads is arranged in a conveyance direction. In the present embodiment, the recording heads include a total of five line recording heads for the four color inks, i.e., yellow (Y), magenta (M), cyan (C), and black (Bk), and a reaction liquid. In addition, the number of colors and the number of recording heads are not limited to five. A method using any one of a heating element, a piezoelectric element, an electrostatic element, and microelectromechanical systems (MEMS) can be used as the ink jet method. The inks of respective colors are supplied to the recording heads from ink tanks (not illustrated) via ink tubes (not illustrated). A sheet printed by the recording unit 230 is conveyed to an in-line scanner (not illustrated) arranged on the downstream side of the recording unit 230 in the conveyance direction through the printing belt unit 220. The in-line scanner (not illustrated) can detect a misalignment and a color density of the image formed on the sheet, and can output a detection result for correcting the image.

The drying module 300 includes a decoupling unit 320, a drying belt unit 330, and a warm air blowing unit 340. The drying module 300 enhances fixability of an ink with a sheet by decreasing a liquid contained in the ink applied to the sheet by the recording unit 230. A sheet on which an ink image is formed by the recording unit 230 of the printing module 200 is conveyed to the decoupling unit 320 arranged inside the drying module 300. The decoupling unit 320 moderately retains the sheet on the belt by applying wind pressure from the upper side, and conveys the sheet with a frictional force of the belt. In this way, the sheet on which an ink image has been formed at the printing belt unit 220 is prevented from being skewed. The warm air blowing unit 340 arranged above the drying belt unit 330 blows hot air onto the sheet conveyed from the decoupling unit 320 while the sheet is being sucked and conveyed by the drying belt unit 330, so that the ink applied to the surface of the sheet is dried.

The fixing module 400 includes a fixing belt unit 410. The fixing belt unit 410 makes the ink solvent sufficiently penetrate the sheet conveyed from the drying module 300 by making the sheet pass between a heated upper belt and a heated lower belt.

The cooling module 500 includes a plurality of cooling units 510 for cooling the hot sheet conveyed from the fixing module 400. Each of the cooling units 510 increases pressure within a cooling box by taking the ambient air into the cooling box with a fan, and cools a sheet by applying wind blown from a nozzle formed on the conveyance guide to the sheet. The cooling units 510 are arranged on both sides of the conveyance path and cool the sheet from both sides.

The cooling module 500 further includes a conveyance path switching unit 520. The conveyance path switching unit 520 switches a sheet conveyance path depending on whether a sheet is conveyed to the reversing module 600 or a both side conveyance path 180 used when two-sided printing is executed. When two-sided printing is executed, a sheet is conveyed to a conveyance path 530 on the lower side of the cooling module 500 by the conveyance path switching unit 520. The sheet is conveyed to a both side conveyance path 180 within the feeding module 100 from the conveyance path 530 via a conveyance path 430 within the fixing module 400, a conveyance path 350 within the drying module 300, and a conveyance path 250 within the printing module 200. The sheet is conveyed to the pre-imaging registration correction unit 210, the printing belt unit 220, and the recording unit 230 of the printing module 200 from the both side conveyance path 180 again, so that an ink image is formed by the recording unit 230. In addition, a first reversing portion 420 for reversing the front and back sides of the sheet is arranged on the conveyance path 430 of the fixing module 400.

The reversing module 600 includes a second reversing portion 640. The second reversing portion 640 reverses the front and back sides of the conveyed sheet. With this configuration, the reversing module 600 can change the front and back sides of the discharged sheet. A discharge port 610 is arranged on the reversing module 600. The discharge port 610 is used as an evacuation destination of erroneous sheets when the erroneous sheets are detected.

The discharge-stacking module 700 includes a top tray 710 and a stacking tray 720. The discharge-stacking module 700 aligns and stacks sheets conveyed from the reversing module 600 on the top tray 710 or the stacking tray 720.

The discharge option unit 800 is an option unit connectable to the downstream side of the discharge-stacking module 700. The discharge option unit 800 includes a discharge tray 810. Further, the discharge option unit 800 can execute post-processing such as binding processing on the sheets.

A printer server 70 is connected to the image forming apparatus 1. The printer server 70 transmits a print job to the image forming apparatus 1. The printer server 70 checks a state of the image forming apparatus 1, monitors a print job, and executes maintenance control such as adjustment of a speed difference of a skew correction unit. The printer server 70 can generally operate various functions included in the image forming apparatus 1.

### Hardware Block Diagram of Image Forming Apparatus

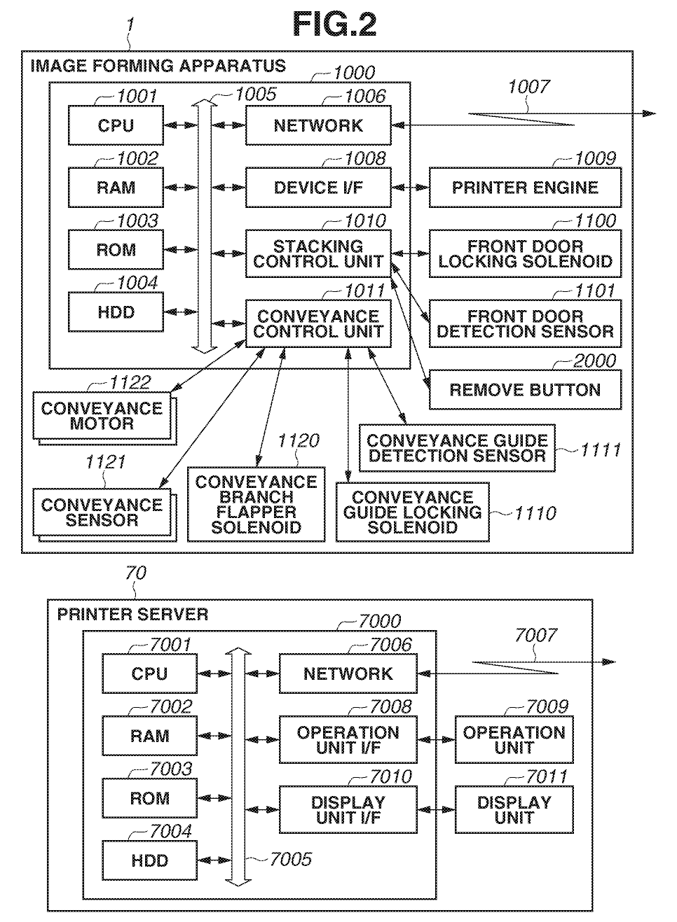

FIG. 2 is a hardware block diagram illustrating a configuration of the image forming apparatus 1 according to the present embodiment. In FIG. 2, a controller unit 1000 controls input and output of sensor signals and device information. A program describing processing content is saved in a read only memory (ROM) 1003 or a hard disk drive (HDD) 1004, and installed in the image forming apparatus 1.

A central processing unit (CPU) 1001 reads a program stored in the ROM 1003 or the HDD 1004 to a random access memory (RAM) 1002 and executes the program. Further, the CPU 1001 generally controls respective devices connected to a system bus 1005.

The RAM 1002 functions as a main memory and a work memory of the CPU 1001. A boot program executed at power-on is stored in the ROM 1003, and an operating system and a main body of a control program of the image forming apparatus 1 are stored in the HDD 1004. The HDD 1004 is used for the purpose of retaining large amounts of data temporarily or on a long-term basis.

A Network 1006 is connected to a local area network 1007, and executes input/output of data and device information with the outside. Further, a program can be installed in the ROM 1003 or the HDD 1004 via the Network 1006.

A device interface (I/F) 1008 is an interface unit for a printer engine 1009. The device I/F 1008 receives and outputs signals for operating and referring to the various motors, sensors, and recording heads connected to the printer engine 1009.

The printer engine 1009 is an ink jet output device. The printer engine 1009 conveys a sheet according to load control executed by the controller unit 1000, and outputs an image transferred from the printer server 70 on the sheet by controlling the recording heads.

A stacking control unit 1010 executes control for stacking sheets through a sensor (not illustrated) and a motor (not illustrated) included in the discharge-stacking module 700. Further, signals are input to the stacking control unit 1010 from a remove button 2000 and a front door detection sensor 1101 for detecting opening and closing states of the front door 2100. The stacking control unit 1010 controls the operation of a front door locking solenoid 1100 capable of fixing the front door 2100 to a closing state. The remove button 2000 functioning as an input unit is an input button for accepting a removal request from the user when the user opens the front door 2100 to remove the stacked sheets. The front door detection sensor 1101 is a sensor for detecting the opening/closing states of the front door 2100. The front door locking solenoid 1100 is arranged to fix the front door 2100 to a closing state, so that the user is prevented from unexpectedly touching the stacked sheets.

A conveyance control unit 1011 executes control to feed a sheet from the feeding module 100.

The conveyance control unit 1011 controls conveyance branch flapper solenoids 1120 which move first to third flappers 2a to 2c for changing a sheet conveyance destination. The conveyance control unit 1011 executes control to convey a sheet in synchronization with the ink discharge timing of the recording heads. Signals are input to the conveyance control unit 1011 from a plurality of conveyance sensors 1121. Based on the signals received from the plurality of conveyance sensors 1121, the conveyance control unit 1011 controls a plurality of conveyance motors 1122.

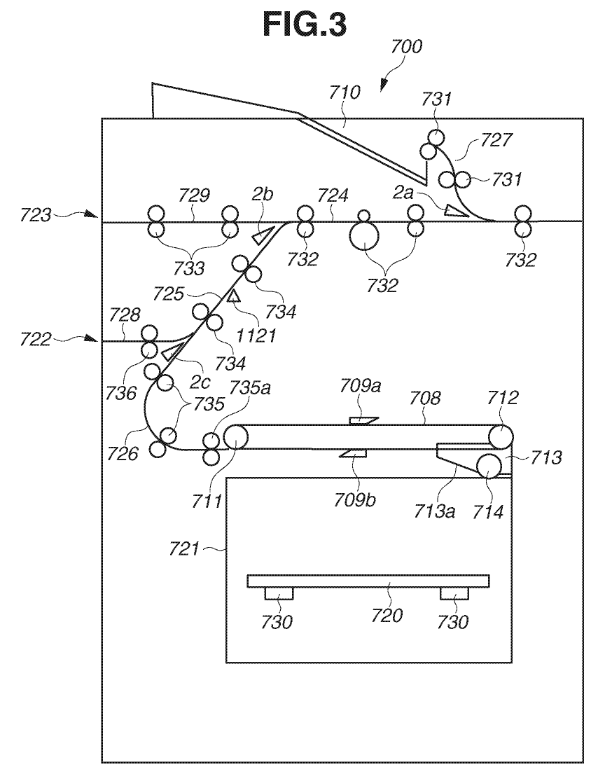

As illustrated in FIG. 3 described below, the plurality of conveyance branch flapper solenoids 1120 is present, and each of the conveyance branch flapper solenoids 1120 is arranged at each of conveyance branch points. When the CPU 1001 detects change of a state of the conveyance sensor 1121, the CPU 1001 stores sheet detection time (hereinafter, called "detection time") in the RAM 1002 in order to use the detection time for control processing. In a case where the detection time is not a timing expected from a sheet position, for example, the CPU 1001 determines occurrence of a jam such as a conveyance failure or malfunction of a device.

Further, a signal is input to the conveyance control unit 1011 from a conveyance guide detection sensor 1111. The conveyance control unit 1011 functions to control a conveyance guide locking solenoid 1110.

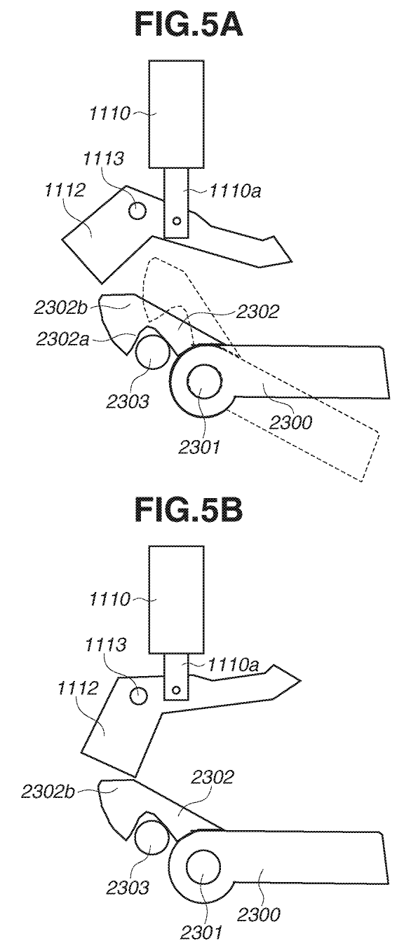

The conveyance guide detection sensor 1111 detects opening of a portion of a conveyance guide 2102 constituting a sheet conveyance path, which is openable and closable for user work such as jam clearance processing. The conveyance guide locking solenoid 1110 can fix the conveyance guide 2102 in a closing state. The conveyance guide locking solenoid 1110 is a constituent element of a locking mechanism described below in FIGS. 5A and 5B.

Although the controller unit 1000 is provided as a single unit, a plurality of controller units 1000 may separately be arranged for each of the modules 100, 200, 300, 400, 500, and 600. In this case, a specific controller unit generally controls the other controller units.

A CPU 7001 included in the printer server 70 reads a program stored in a ROM 7003 or an HDD 7004 to a RAM 7002 and executes the program. Further, the CPU 7001 generally controls the respective devices connected to a system bus 7005. The RAM 7002 functions as a main memory and a work memory of the CPU 7001. A boot program executed at power-on is stored in the ROM 7003, and an operating system and a main body of a control program of the printer server 70 are stored in the HDD 7004. The HDD 7004 is used for the purpose of retaining large amounts of data temporarily or on a long-term basis.

A Network 7006 is connected to a local area network 7007, and executes input and output of data and device information with the outside. Further, a program can be installed in the ROM 7003 or the HDD 7004 via the Network 7006. An operation unit I/F 7008 is connected to an operation unit 7009, and the operation unit 7009 accepts inputs of various settings and operation instructions from the user. A display unit I/F 7010 is connected to a display unit 7011, and the display unit 7011 serves as an output device for displaying data exchanged with the outside and various settings stored in the RAM 702 as still images and moving images.

In the present embodiment, the stacking control unit 1010 controls the front door locking solenoid 1100, and the conveyance control unit 1011 controls the conveyance guide locking solenoid 1110. However, the configuration is not limited to the above, and the stacking control unit 1010 may control the conveyance guide locking solenoid 1110. In other words, one control unit may control both of the front door locking solenoid 1100 and the conveyance guide locking solenoid 1110.

### Schematic Diagram of Stacking Apparatus

Next, a configuration of the discharge-stacking module 700 serving as a sheet stacking apparatus is described. FIG. 3 is a diagram illustrating a cross-sectional view of the discharge-stacking module 700. A sheet stacking operation executed by the discharge-stacking module 700 is described with reference to FIG. 3. The discharge-stacking module 700 includes a top tray 710, a stacking tray 720 functioning as a stacking portion, a first flapper 2a, a second flapper 2b, a third flapper 2c, a plurality of conveyance guides for forming a conveyance path, and a plurality of conveyance rollers for conveying a sheet. The discharge-stacking module 700 further includes a gripper belt 708, grippers 709, a leading end stopper 713, and a drawing belt 714. For example, the top tray 710 is used when a printed sample page is discharged. The stacking tray 720 is used when a large number of sheets are stacked. The first flapper 2a, the second flapper 2b, and the third flapper 2c are arranged at branch points of the conveyance path.

A horizontal conveyance path 724 is arranged horizontally in order to convey a sheet from an upstream end of a conveyance path to the second flapper 2b in the discharge-stacking module 700. A plurality of conveyance rollers 732 is arranged on the horizontal conveyance path 724. The plurality of conveyance rollers 732 is connected to a conveyance motor 1122a. The conveyance motor 1122a rotates the plurality of conveyance rollers 732 arranged on the horizontal conveyance path 724.

A conveyance path 725 conveys a sheet from the second flapper 2b to the third flapper 2c. A plurality of conveyance rollers 734 is arranged on the conveyance path 725. The plurality of conveyance rollers 734 is connected to a conveyance motor 1122b. The conveyance motor 1122b rotates the plurality of conveyance rollers 734 arranged on the conveyance path 725.

A stacking tray conveyance path 726 conveys a sheet from the third flapper 2c to a stacking unit 721. A plurality of conveyance rollers 735 is arranged on the stacking tray conveyance path 726 having a curved portion. The plurality of conveyance rollers 735 is connected to a conveyance motor 1122c. The conveyance motor 1122c rotates the plurality of conveyance rollers 735 arranged on the stacking tray conveyance path 726.

A top tray conveyance path 727 conveys a sheet from the first flapper 2a to the top tray 710. A plurality of conveyance rollers 731 is arranged on the top tray conveyance path 727. The plurality of conveyance rollers 731 is connected to a conveyance motor 1122d. The conveyance motor 1122d rotates the plurality of conveyance rollers 731 arranged on the top tray conveyance path 727.

A first option conveyance path 728 conveys a sheet from the third flapper 2c to the discharge option unit 800. Conveyance rollers 736 are arranged on the first option conveyance path 728. The conveyance rollers 736 are connected to a conveyance motor 1122e. The conveyance motor 1122e rotates the conveyance rollers 736 arranged on the first option conveyance path 728.

A second option conveyance path 729 is a straight conveyance path which conveys a sheet from the second flapper 2b to the discharge option unit 800. A plurality of conveyance rollers 733 is arranged on the second option conveyance path 729. The plurality of conveyance rollers 733 is connected to a conveyance motor 1122f. The conveyance motor 1122f rotates the plurality of conveyance rollers 733 arranged on the second option conveyance path 729.

The conveyance control unit 1011 controls driving of a conveyance branch flapper solenoid 1120a (see FIG. 2) to cause the first flapper 2a to switch a sheet conveyance path to the top tray conveyance path 727 or the horizontal conveyance path 724. In addition, the top tray conveyance path 727 branches from the horizontal conveyance path 724. The conveyance control unit 1011 controls driving of a conveyance branch flapper solenoid 1120b (see FIG. 2) to cause the second flapper 2b to switch a conveyance destination of the sheet passing through the horizontal conveyance path 724 to the second option conveyance path 729 or the conveyance path 725. The conveyance control unit 1011 controls driving of a conveyance branch flapper solenoid 1120c (see FIG. 2) to cause the third flapper 2c to switch a sheet conveyance path to the first option conveyance path 728 or the stacking tray conveyance path 726.

### Descriptions of Discharge Destination

In the present embodiment, the discharge-stacking module 700 has three discharge destinations, i.e., the top tray 710 as a first discharge destination, the stacking tray 720 as a second discharge destination, and the discharge option unit 800 connected to the downstream side of the discharge-stacking module 700 as a third discharge destination.

The discharge option unit 800 can further be connected to the downstream side of the discharge-stacking module 700. The discharge-stacking module 700 includes the first option conveyance path 728 and the second option conveyance path 729, and a conveyance path to be used is selected depending on a type of the option unit connected to the discharge-stacking module 700. In the present embodiment, a first finisher is connected to the discharge-stacking module 700 as the discharge option unit 800, and the first option conveyance path 728 is used (see FIG. 1).

The second option conveyance path 729 can be used in a case where the discharge option unit 800 connected to the discharge-stacking module 700 is a second finisher whose conveyance path is located at a height different from a height of the conveyance path of the first finisher. For example, the discharge-stacking module 700 may be used as the second finisher. In other words, a second discharge-stacking module 700 having a configuration similar to the configuration of the first discharge-stacking module 700 may consecutively be connected to the downstream side of the first discharge-stacking module 700.

In other words, a sheet conveyed through the second option conveyance path 729 of the first discharge-stacking module 700 may be conveyed to the horizontal conveyance path 724 of the second discharge-stacking module 700. In this way, it is possible to double the total stacking amount. However, the number of option conveyance paths is not limited to two, and may be one, or three or more.

### Operation depending on Discharge Destination

Next, a basic operation of the discharge-stacking module 700 executed depending on a set discharge destination is described. In a case where a sheet is discharged to the top tray 710 as the first discharge destination, the sheet is discharged to the top tray 710 via the upstream side of the horizontal conveyance path 724 and the top tray conveyance path 727. In a case where a sheet is discharged to the stacking tray 720 as the second discharge destination, the sheet is discharged to the stacking tray 720 via the horizontal conveyance path 724, the conveyance path 725, and the stacking tray conveyance path 726. In a case where a sheet is discharged to the discharge option unit 800 as the third discharge destination, in the present embodiment, the sheet is discharged to the discharge option unit 800 via the horizontal conveyance path 724, the conveyance path 725, and the first option conveyance path 728.

In a case where the user specifies the top tray 710 arranged on the upper face of the discharge-stacking module 700 as a sheet stacking portion by operating the operation unit included in the main body, the first flapper 2a switches a sheet conveyance path to the top tray conveyance path 727. The sheet is conveyed by the conveyance rollers 732 and 731, and discharged to the top tray 710.

In a case where the user specifies the stacking tray 720 as a sheet stacking portion by operating the operation unit included in the main body, the first flapper 2a switches a sheet conveyance path to the horizontal conveyance path 724. The sheet is conveyed to the second flapper 2b by the plurality of conveyance rollers 732. The second flapper 2b switches a sheet conveyance path to the conveyance path 725, and the third flapper 2c switches a sheet conveyance path to the stacking tray conveyance path 726. The sheet is conveyed to the stacking unit 721 by the plurality of conveyance rollers 734 and 735. The sheet is conveyed by the discharge rollers 735a while being gripped by any one of a first gripper 709a and a second gripper 709b (hereinafter, called "gripper 709") attached to the gripper belt 708. The gripper belt 708 is stretched around a drive pulley 711 and a driven pulley 712, and rotates in a rotation direction by being driven by a belt motor (not illustrated).

The sheet is conveyed at the upper part of the stacking tray 720 while being gripped by the gripper 709 and the discharge rollers 735a. The sheet conveyed in the above-described state abuts on an abutting inclined face (abutting portion) 713a of the leading end stopper 713, and is released from the gripper 709. The sheet is guided to the abutting inclined face 713a of the leading end stopper 713 through the drawing belt 714, so that a position of a leading end of the sheet is aligned. At the same time, a trailing end of the sheet is separated from the discharge rollers 735a, so that the sheet is stacked on the stacking tray 720 in a state where a position of the leading end is regulated.

Herein, a distance between the drawing belt 714 and the discharge rollers 735a is set to be shorter than a length of a sheet to be discharged. At this time, a position of the stacking tray 720 is controlled, so that the drawing belt 714 is in contact with the upper face of the sheet bundle stacked on the stacking tray 720. Thereafter, a next sheet discharged through the discharge rollers 735a is conveyed to the upper part of the stacking tray 720 while a leading end of the sheet is being gripped by the next gripper 709, and the sheet is stacked on the stacking tray 720. Then, in a case where the stacked sheets are removed after the job is ended or in the middle of the job, the stacking tray 720 is moved down to a sheet removal position on the lower side by a lifting portion (lifting unit) 730.

The top tray 710 is arranged on the upper face of the discharge-stacking module 700, whereas the stacking unit 721 is arranged inside the discharge-stacking module 700. Because the stacking unit 721 is arranged inside the apparatus, stacked sheets are prevented from being misaligned or collapsed by being touched by the user. In other words, user access to the stacking unit 721 is limited by the front door 2100 described below. When sheets are being stacked on the stacking unit 721, a locking mechanism described below prevents the front door 2100 from being opened.

In a case where the user specifies the discharge tray 810 of the discharge option unit 800 as a sheet stacking portion by operating the operation unit included in the main body, the first flapper 2a switches a sheet conveyance path to the horizontal conveyance path 724. The sheet is conveyed to the second flapper 2b by the conveyance rollers 732. The second flapper 2b switches the sheet conveyance path to the conveyance path 725, and the third flapper 2c switches the sheet conveyance path to the first option conveyance path 728. The sheet is conveyed to the discharge option unit 800 through the plurality of conveyance rollers 734 and 736.

The conveyance motor 1122 for each of the conveyance paths 724, 725, 726, 727, 728, and 729 is driven when a sheet has reached the conveyance path, and kept driving until the sheet is discharged to a discharge destination. The top tray 710, the stacking unit 721, and first and second discharge ports 722 and 723 connected to the discharge option unit 800 are examples of the discharge destination. In addition, the conveyance motor 1122 for a conveyance path where the sheet does not pass at all is not driven. For example, in a case where the sheet is discharged to the top tray 710, only the conveyance motor 1122a for the horizontal conveyance path 724 and the conveyance motor 1122d for the top tray conveyance path 727 are driven. On the other hand, in a case where the sheet is discharged to the top tray 710, the conveyance motor 1122b for the conveyance path 725, the conveyance motor 1122c for the stacking tray conveyance path 726, the conveyance motor 1122e for the first option conveyance path 728, and the conveyance motor 1122f for the second option conveyance path 729 are not driven.

### Determination of Jam Occurrence and Jam Clearance Processing

The conveyance sensor 1121 is arranged on the conveyance path 725. The conveyance sensor 1121 detects a leading end and a trailing end of the sheet conveyed through the conveyance path 725. In a case where time when a sheet is detected by the conveyance sensor 1121 does not fall within a prescribed period considering a conveyance error, in which the sheet is expected to reach the conveyance sensor 1121, the CPU 1001 determines that a conveyance failure such as a paper jam (also called "jam") has occurred. For example, the conveyance sensor 1121 does not detect a leading end or a trailing end of the sheet in a case where a paper jam occurs while the sheet is passing through the conveyance path 725. Therefore, the CPU 1001 determines that a paper jam has occurred. In a case where a paper jam occurs, the conveyance rollers 734 of the conveyance path 725 are stopped by the conveyance control unit 1011, so that the sheet remains in the conveyance path 725.

A first conveyance guide 2102a described below is a conveyance guide constituting a part of the conveyance path 725. The first conveyance guide 2102a is an openable/closable guide capable of exposing the conveyance path. In other words, the user can release a part of the conveyance path 725 to clear a jam by opening the first conveyance guide 2102a.

### Front Door and Conveyance Guide

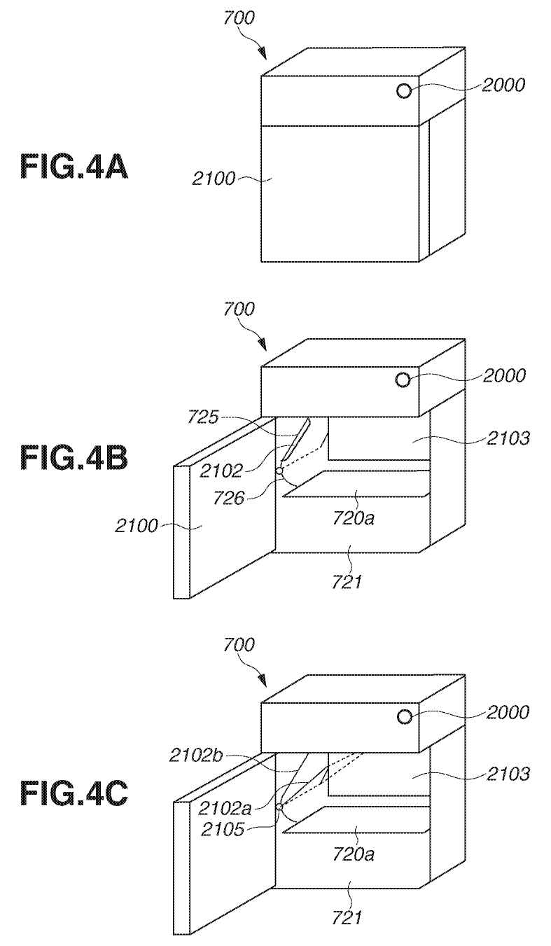

Next, the front door 2100 and the conveyance guide 2102 are described. The front door 2100 constitutes an exterior front face of the discharge-stacking module 700. FIGS. 4A-4C are diagrams schematically illustrating an opening/closing structure of the front door 2100 and the conveyance guide 2102. FIG. 4A illustrates the discharge-stacking module 700 with the front door 2100 in a closed state (located at a closing position). FIG. 4B illustrates the discharge-stacking module 700 with the front door 2100 in an open state (located at an opening position) and the first conveyance guide 2102a in a closed state. FIG. 4C illustrates the discharge-stacking module 700 with the front door 2100 in an open state and the first conveyance guide 2102a in an open state. As illustrated in FIG. 4A, the front door 2100 covers the stacking tray 720 and the first conveyance guide 2102a in a state where the front door 2100 is located at the closing position, so that the user cannot access the stacking tray 720 and the first conveyance guide 2102a. On the other hand, as illustrated in FIGS. 4B and 4C, the front door 2100 exposes the stacking tray 720 and the first conveyance guide 2102a in a state where the front door 2100 is located at the opening position, so that the user can access the stacking tray 720 and the first conveyance guide 2102a.

A remove button 2000 which the user presses to open the front door 2100 is arranged on the exterior front face of the discharge-stacking module 700. In addition, a position of the remove button 2000 is not limited to the above position. The remove button 2000 may be arranged on the exterior upper face of the discharge-stacking module 700. Further, the remove button 2000 may be a hard key included in the operation unit of the main body or a soft key included in an operation screen of the operation unit of the main body. Furthermore, the remove button 2000 may be a push-type or lever-type button.

As described above, FIG. 4A illustrates a state where the front door 2100 is closed. When the remove button 2000 is pressed by the user in a state where the front door 2100 is closed, the stacking control unit 1010 cancels a locked state set by the front door locking solenoid 1100 serving as a second prohibition unit, so that the front door 2100 can be opened (see FIG. 4B). However, as described below, depending on a state of the image forming apparatus 1, there is a case where a locked state set by the front door locking solenoid 1100 is not cancelled even if the remove button 2000 is pressed by the user, so that the front door 2100 cannot be opened. For example, the stacking control unit 1010 executes control to prevent the front door 2100 from being opened when sheets are being conveyed and stacked onto the stacking unit 721.

FIG. 4B illustrates a state where the front door 2100 is open from the closed state illustrated in FIG. 4A. A hinge (not illustrated) is attached on the left side of the front door 2100 of the discharge-stacking module 700, so that the front door 2100 can be opened toward a front side by making a left face as a fulcrum point. When the front door 2100 is opened, the first conveyance guide 2102a and the stacking unit 721 are exposed.

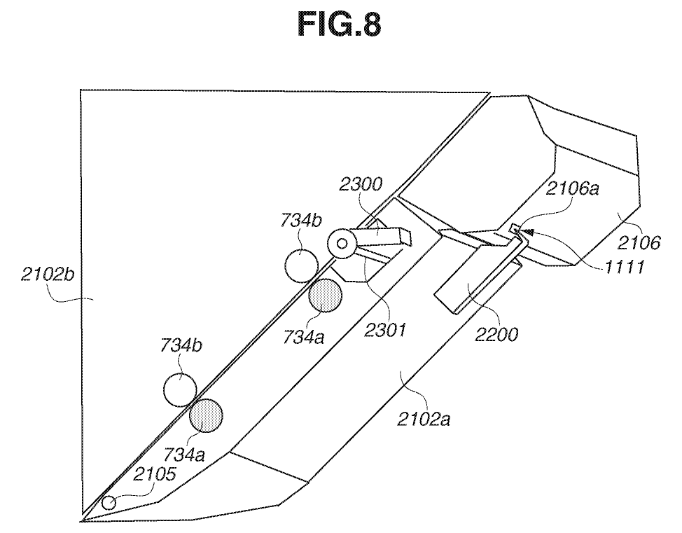

FIG. 4C illustrates a state where the front door 2100 is open, and the first conveyance guide 2102a, which forms the conveyance path 725 together with the second conveyance guide 2102b, is also open. Hereinafter, structures of the first conveyance guide 2102a and the second conveyance guide 2102b are described with reference to FIG. 8.

FIG. 8 is a diagram illustrating a perspective view of a periphery of the first conveyance guide 2102a in a state where the first conveyance guide 2102a is closed. In other words, FIG. 8 is a perspective view of a periphery of the first conveyance guide 2102a in a state illustrated in FIG. 4B. The second conveyance guide 2102b is a conveyance guide fixed to the discharge-stacking module 700. The first conveyance guide 2102a is a conveyance guide openable and closable relative to the second conveyance guide 2102b by making a shaft 2105 as a center. The first conveyance guide 2102a includes a plurality of conveyance rollers 734a, and the second conveyance guide 2102b includes a plurality of conveyance rollers 734b. In a state where the first conveyance guide 2102a is closed, the conveyance rollers 734a and the conveyance rollers 734b form nip portions, so that a sheet can be conveyed thereby. In other words, the first conveyance guide 2102a and the second conveyance guide 2102b form the conveyance path 725 in a state where the first conveyance guide 2102a is closed.

The discharge-stacking module 700 includes a conveyance guide 2106 arranged on the upstream side of the first conveyance guide 2102a in a sheet conveyance direction. An opening portion 2106a is formed on the conveyance guide 2106. The conveyance guide detection sensor 1111 and a plate spring are arranged inside the opening portion 2106a. In a state where the first conveyance guide 2102a is closed, a push member 2200 arranged on the first conveyance guide 2102a presses the conveyance guide detection sensor 1111 via the plate spring, so that the conveyance guide detection sensor 1111 can detect a closed state of the first conveyance guide 2102a. In the present embodiment, the conveyance guide detection sensor 1111 is a push switch. However, the present disclosure is not limited to the above, and the conveyance guide detection sensor 1111 can be an optical sensor.

As illustrated in FIG. 4B, an inner cover 2103 is arranged on a depth side of the discharge-stacking module 700. The inner cover 2103 covers the member such as a motor. A sheet discharged from the stacking tray conveyance path 726 is stacked on a stacking face 720a of the stacking tray 720. The lifting portion 730 illustrated in FIG. 3 supports the lower face of the stacking tray 720, and also adjusts the position of the stacking face 720a up and down according to the amount of stacked sheets. In this way, a large number of sheets can be stacked in an aligned state.

In the present embodiment, the front door 2100 cannot be opened when a job for discharging sheets to the stacking unit 721 is being executed. On the other hand, the front door 2100 can be opened when a job for discharging sheets to the other discharge destination is being executed. Specifically, the front door 2100 cannot be opened when a sheet is being conveyed through the stacking tray conveyance path 726. On the other hand, the front door 2100 can be opened when a sheet is being conveyed through any one of the horizontal conveyance path 724, the conveyance path 725, the top tray conveyance path 727, the first option conveyance path 728, and the second option conveyance path 729. In other words, as illustrated in FIG. 4B, in a state where the front door 2100 is open, and the first conveyance guide 2102a is closed, a sheet can be conveyed to the top tray 710 and an option unit connected to the downstream side. In other words, the user can open the front door 2100 to remove the stacked sheets as products when a job for conveying sheets to a discharge destination other than the stacking unit 721 is being executed.

As illustrated in FIG. 4C, the conveyance guide 2102 includes the second conveyance guide 2102b fixed to the discharge-stacking module 700 and the first conveyance guide 2102a capable of being opened. The first conveyance guide 2102a is a member rotating about the shaft 2105. The first conveyance guide 2102a rotates in an opening direction, so that the conveyance path 725 formed by the conveyance guide 2102 is open. Although a sheet cannot be conveyed in the above-described state, the user can access the inner part of the conveyance path 725. In other words, in a state where the first conveyance guide 2102a is open as illustrated in FIG. 4C, the user can perform removal work of a sheet stopped by a paper jam. In other words, while a sheet is being conveyed at the discharge-stacking module 700, the first conveyance guide 2102a is locked by a locking mechanism described below so that the first conveyance guide 2102a cannot be opened.

However, the present embodiment is not limited thereto, and a sheet can be conveyed at the horizontal conveyance path 724 and the second option conveyance path 729 in FIG. 3 in a state illustrated in FIG. 4C. In this case, the user can perform jam clearance processing and cleaning of the conveyance path 725 when a sheet is discharged to a discharge destination where the conveyance path 725 is not used. In the above-described state, a sheet cannot be conveyed at a conveyance path other than the horizontal conveyance path 724 and the second option conveyance path 729 because the first conveyance guide 2102a is open. However, there is a possibility that the conveyance sensor 1121 arranged on the conveyance path 725 makes an erroneous detection if the first conveyance guide 2102a is opened when conveyance is being executed at either the horizontal conveyance path 724 or the second option conveyance path 729. Therefore, in the present embodiment, the first conveyance guide 2102a is locked and cannot be opened when conveyance is being executed at either the horizontal conveyance path 724 or the second option conveyance path 729.

### Schematic Diagram of Locking Mechanism

Next, a locking mechanism for locking the first conveyance guide 2102a is described with reference to FIGS. 5A and 5B.

The conveyance guide locking solenoid 1110 includes an actuating member 1110a whose position is changed depending on whether power is supplied to the conveyance guide locking solenoid 1110. The actuating member 1110a is coupled to a locking member 1112 capable of freely swinging around a swinging shaft 1113. The locking member 1112 swings around the swinging shaft 1113 when the position of the actuating member 1110a is changed.

A pin 2303 is arranged on the lower side of the locking member 1112. A latching hook 2302 provided as an engagement portion with which the pin 2303 engages, is arranged on the first conveyance guide 2102a. The latching hook 2302 is arranged on the first conveyance guide 2102a, and is freely rotatable about a shaft 2301. The latching hook 2302 includes a concave portion 2302a with which the pin 2303 as an engaged portion engages, and an abutting part 2302b abutting on the locking member 1112. An operation portion 2300 operated by the user is further arranged on the latching hook 2302. The operation portion 2300 and the concave portion 2302a can rotate integrally.

FIG. 5A illustrates a power-off state where power is not supplied to the conveyance guide locking solenoid 1110. In FIG. 5A, the concave portion 2302a of the latching hook 2302 and the pin 2303, expressed by solid lines, engage with each other. In this state, the first conveyance guide 2102a is retained (latched) by the latching hook 2302 and cannot be opened. When the operator operates the operation portion 2300 to rotate the latching hook 2302 in a clockwise direction, engagement of the concave portion 2302a and the pin 2303 is cancelled as expressed by dotted lines. Therefore, retention of the first conveyance guide 2102a at the closing position caused by the latching hook 2302 is cancelled, so that the first conveyance guide 2102a is opened.

FIG. 5B illustrates a power-on state where power is supplied to the conveyance guide locking solenoid 1110. When power is supplied to the conveyance guide locking solenoid 1110, the actuating member 1110a moves up from the state illustrated in FIG. 5A. In tandem with the upward movement of the actuating member 1110a, the locking member 1112 swings in the counter-clockwise direction about the swinging shaft 1113, so that the locking mechanism is brought into a state illustrated in FIG. 5B. The locking member 1112 located at a locking position illustrated in FIG. 5B regulates the movement of the latching hook 2302. Therefore, in FIG. 5B, the locking member 1112 regulates rotation of the latching hook 2302 in the clockwise direction by making contact with the abutting portion 2302b of the latching hook 2302. In this state, even if the operator tries to rotate the latching hook 2302 in the clockwise direction by operating the operation portion 2300, the latching hook 2302 interferes with the locking member 1112 and cannot be rotated. Therefore, as illustrated in FIG. 5B, the first conveyance guide 2102a cannot be opened because the latching hook 2302 cannot be rotated. In other words, FIG. 5B illustrates a state where a first prohibition unit configured of the conveyance guide locking solenoid 1110 and the locking member 1112 prohibits the first conveyance guide 2102a from opening.

The above-described configuration of the first prohibition unit is merely an example, and the first conveyance guide 2102a may non-rotatably be locked by another mechanism. In other words, in the above-described embodiment, the locking member 1112 for regulating the movement of the latching hook 2302 engaging with the pin 2303 is arranged as a regulation member. However, a regulation member which directly makes contact with the first conveyance guide 2102a to prevent the first conveyance guide 2102a from moving from the closing position may be arranged. In this case, the regulation member for preventing the first conveyance guide 2102a from moving from the closing position is moved by a driving unit such as a solenoid.

Although a locking mechanism for locking the first conveyance guide 2102a is described as an example, the same is also applicable to a locking mechanism for locking the front door 2100.

### Descriptions of Locked State

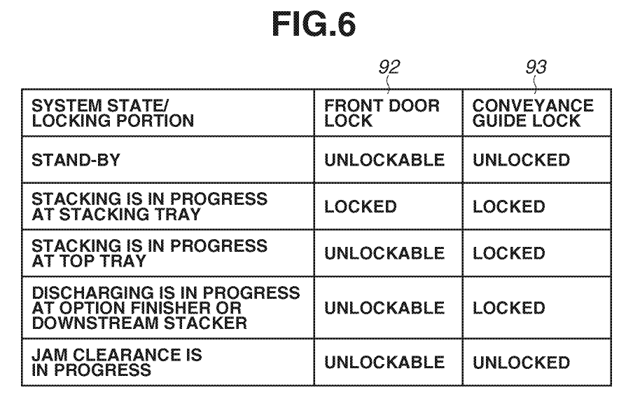

A relationship in a combination of a system state and a locked state is described with reference to FIG. 6.

FIG. 6 is a table illustrating a system state of the image forming apparatus 1 and locked states of the front door 2100 and the first conveyance guide 2102a for the system state.

Herein, Front Door Lock 92 describes whether the front door 2100 can be opened. In FIG. 6, "Unlockable" described in the Front Door Lock 92 indicates a state where sheets can be removed by pressing the remove button 2000. In other words, "Unlockable" indicates a state where the front door 2100 is allowed to open. In FIG. 6, "Locked" described in the Front Door Lock 92 indicates a state where the front door 2100 is locked so that sheets cannot be removed even if the remove button 2000 is pressed.

In FIG. 6, "Unlocked" described in Conveyance Guide Lock 93 indicates a state where the first conveyance guide 2102a is not prohibited from opening so that the user can open the first conveyance guide 2102a. When "Locked" is described in the Conveyance Guide Lock 93, the first conveyance guide 2102a is prohibited from opening, so that the user cannot open the first conveyance guide 2102a.

In a case where stacked sheets are to be removed in the unlockable state, the user unlocks the front door 2100 by pressing the remove button 2000. In addition, in order to prevent interference, an alignment member (not illustrated) for holding the stacked sheets may be evacuated from the sheets when the remove button 2000 is pressed. Further, when the remove button 2000 is pressed, stacked sheets may be placed onto a sheet removing carriage by moving down an arm supporting the stacking face (not illustrated).

When the system state in FIG. 6 is "Stand-by", the state of the front door 2100 is "Unlockable", whereas the state of the first conveyance guide 2102a is "Unlocked". The front door 2100 is basically locked. This is intended to prevent the user from abruptly touching and misaligning sheets stacked on the stacking tray 720 to prevent degradation of stacking performance. In the stand-by state, conveyance is not executed. Therefore, the first conveyance guide 2102a is unlocked in the stand-by state.

When the system state in FIG. 6 is "Stacking is in progress at stacking tray", the states of the front door 2100 and the first conveyance guide 2102a are "Locked". When the system state is "Stacking is in progress at stacking tray", printing operation for stacking sheets on the stacking tray 720 is being executed. In this state, if the front door 2100 is opened, stacked sheets may be touched and collapsed by the user because stacking is being executed in a periphery of the stacking tray 720. Therefore, the front door 2100 is locked. In tandem with conveyance of sheets at the conveyance path 725, the inner portion of the discharge-stacking module 700 is in operation. Therefore, the first conveyance guide 2102a is locked.

When the system state in FIG. 6 is "Stacking is in progress at top tray", the state of the front door 2100 is "Unlockable", whereas the state of the first conveyance guide 2102a is "Locked". When the system state is "Stacking is in progress at top tray", sheets are being discharged and stacked on the top tray 710. In this state, the front door 2100 is unlockable because a periphery of the stacking tray 720 is not in operation. In tandem with conveyance of sheets at the conveyance paths 724 and 727, the inner portion of the discharge-stacking module 700 is in operation. Therefore, the first conveyance guide 2102a is locked.

When the system state in FIG. 6 is "Discharging is in progress at option finisher or downstream stacker", the state of the front door 2100 is "Unlockable", whereas the state of the first conveyance guide 2102a is "Locked". When sheets are being discharged to an option finisher or a downstream stacker, the conveyance path 725 located on the inner side of the conveyance guide 2102 is in operation. On the other hand, the stacking tray conveyance path 726 in a periphery of the stacking tray 720 is not in operation. Therefore, the front door 2100 can be unlocked. In tandem with conveyance of sheets at the conveyance paths 724, 725, and 729, the inner portion of the discharge-stacking module 700 is in operation. Therefore, the first conveyance guide 2102a is locked.

When the system state in FIG. 6 is "Jam clearance is in progress", the state of the front door 2100 is "Unlockable", whereas the state of the first conveyance guide 2102a is "Unlocked". When jam clearance processing is in progress, the CPU 1001 periodically checks the state of the conveyance sensor 1121, and determines whether jam clearance processing for removing a sheet is executed by the user. However, a movable member such as the conveyance motor 1122 is not moved, so that the inner portion of the discharge-stacking module 700 is stopped. Therefore, the front door 2100 can be unlocked. The first conveyance guide 2102a is unlocked in order to allow the user to perform jam clearance processing.

According to the present embodiment, when sheets stacked on the stacking portion are removed, the front door 2100 through which stacked sheets are removed is unlocked. Then, the first conveyance guide 2102a exposed from the opened front door 2100 is locked and cannot be opened. In this way, stacked sheets can be removed from one and the same front door opened when jam clearance processing is executed. Therefore, it is possible to obtain the following operational advantage while achieving space saving. In other words, while printing operation is being executed by accepting a job for stacking sheets to another stacking portion, the user is allowed to open the front door to remove stacked sheets.

### Flowchart of Locking Operation

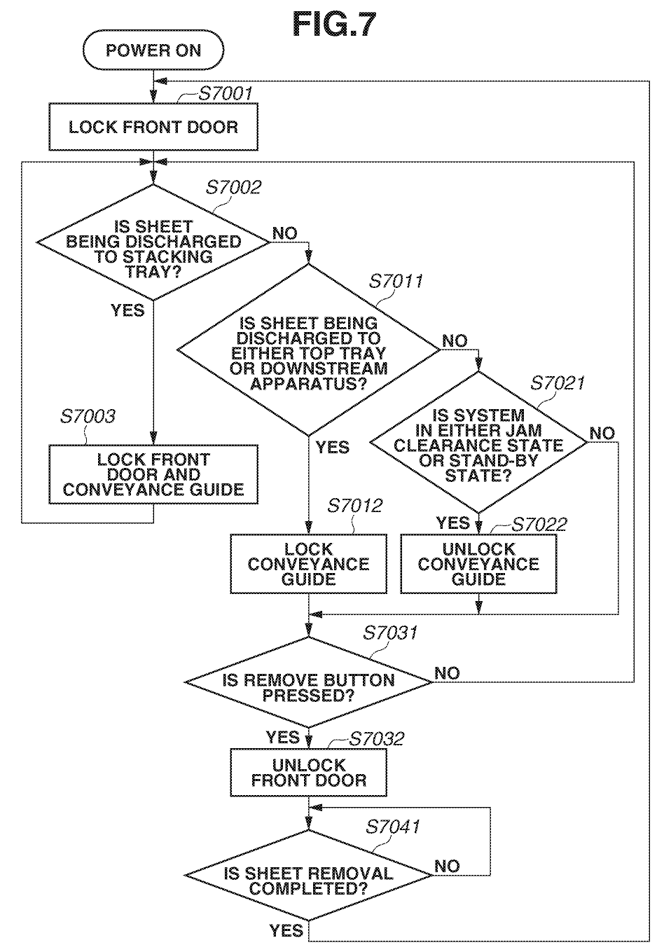

"Locking Control" for implementing a locked state described in FIG. 6 of the present embodiment is described with reference to a flowchart in FIG. 7, illustrating locking control of the front door 2100 and the conveyance guide 2102 according to the present embodiment.

The processing illustrated in FIG. 7 is started by the CPU 1001 when the image forming apparatus 1 is turned on.

When the processing is started, in step S7001, the CPU 1001 drives the front door locking solenoid 1100 to lock the front door 2100.

In step S7002, the CPU 1001 refers to the RAM 1002, and determines whether the job is a print job for discharging a sheet to the stacking tray 720 based on the job information.

In a case where the determination result is "YES" (YES in step S7002), the processing proceeds to step S7003. In step S7003, the CPU 1001 locks the front door 2100 and the conveyance guide 2102 by driving the front door locking solenoid 1100 and the conveyance guide locking solenoid 1110. The above-described state corresponds to a state described in FIG. 6, "Stacking is in progress at stacking tray". Herein, the CPU 1001 maintains the locked states in a case where the solenoids 1100 and 1110 have already been driven. The same is also applicable to the subsequent processing. Then, the processing returns to step S7002.

In a case where a determination result is "NO" (NO in step S7002), the processing proceeds to step S7011. In step S7011, the CPU 1001 refers to the RAM 1002, and determines whether the job is a print job for discharging a sheet to any one of the top tray, the option finisher, and the downstream stacker based on the job information. In a case where a determination result is "YES" (YES in step S7011), the processing proceeds to step S7012. In step S7012, the CPU 1001 locks the conveyance guide 2102 by driving the conveyance guide locking solenoid 1110. The above-described state corresponds to either "Stacking is in progress at top tray" or "Discharging is in progress at option finisher or downstream stacker" in FIG. 6.

In a case where a determination result is "NO" (NO in step S7011), the processing proceeds to step S7021. In step S7021, the CPU 1001 determines whether a system is in either a jam clearance state or a stand-by state. The CPU 1001 refers to the conveyance sensor 1121 for a sheet detection state, and refers to the RAM 1002 for a plurality of pieces of information related to the operation of the image forming apparatus 1, including job information and overall system state information. Then, the CPU 1001 determines whether the system is in either a jam clearance state or a stand-by state based on the sheet detection state and the plurality of pieces of information.

In a case where a determination result is "YES" (YES in step S7021), the processing proceeds to step S7022. In step S7022, the CPU 1001 unlocks the first conveyance guide 2102a by stopping driving of the conveyance guide locking solenoid 1110. The above-described state corresponds to either "Stand-by" or "Jam clearance is in progress" in FIG. 6. Then, the processing proceeds to step S7031.

In a case where a determination result is "NO" (NO in step S7021), the processing proceeds to step S7031. In step S7031, the CPU 1001 determines whether the remove button 2000 is pressed.

In a case where a determination result is "YES" (YES in step S7031), the processing proceeds to step S7032. In step S7032, the CPU 1001 unlocks the front door 2100 by stopping drive of the front door locking solenoid 1100.

In a case where a determination result is "NO" (NO in step S7031), the processing returns to step S7002.

In step S7041, the CPU 1001 determines whether the user has removed sheets stacked on the stacking tray 720, based on whether the front door detection sensor 1101 detects a closing state of the front door 2100 after detecting an opening state.

In a case where a detection result in step S7041 is "YES" (YES in step S7041), the processing returns to step S7001. In a case where a detection result in step S7041 is "NO" (NO in step S7041), the processing returns to step S7041. Then, the processing is executed repeatedly.

As described above, in the present embodiment, the first conveyance guide 2102a is exposed when the front door 2100 is opened. In order to clear a jammed sheet, the first conveyance guide 2102a can be opened. However, in a case where jam clearance processing is not desired, the first conveyance guide 2102a is locked and cannot be opened even if the front door 2100 is opened. This is intended to prevent the first conveyance guide 2102a from being opened when a sheet is guided through the first conveyance guide 2102a.

Space saving is achieved by using a common door for removing stacked sheets and executing jam clearance processing. While printing operation is being executed by accepting a job for stacking sheets to another stacking portion, the user is allowed to open the front door to remove stacked sheets. In other words, because sheets can be removed from the stacking tray 720 where stacking is completed, while sheets are continuously stacked on another stacking portion, operation can be efficiently executed without stopping the image forming apparatus 1.

According to the present disclosure, it is possible to prevent occurrence of a conveyance failure while a job is being executed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-079277, filed May 12, 2025, which is hereby incorporated by reference herein in its entirety.

What is claimed is:

1. An image forming apparatus comprising:
an image forming unit configured to form an image on a sheet;
a first stacking portion configured to stack a sheet on which an image is formed by the image forming unit;
a conveyance guide configured to form a part of a conveyance path through which a sheet is conveyed, the conveyance guide being openable and closable relative to the conveyance path;
a first locking unit configured to lock the conveyance guide to prohibit the conveyance guide from being opened;
a front door configured to constitute an exterior front face of the image forming apparatus, the front door being closable at a closing position where the front door is closed and being openable at an opening position where the front door is open to expose the first stacking portion and the conveyance guide;
a second locking unit configured to lock the front door to prohibit the front door from being opened; and
a control unit configured to control the first locking unit and the second locking unit,
wherein, in a case where a sheet is conveyed to the first stacking portion, the control unit prohibits the front door from being opened by controlling the second locking unit, and
wherein, in a case where a sheet is conveyed to a second stacking portion different from the first stacking portion after passing through the conveyance guide, the control unit allows the front door to be opened by controlling the second locking unit, and prohibits the conveyance guide from being opened by controlling the first locking unit.

2. The image forming apparatus according to claim 1, further comprising an input unit configured to receive an input for opening the front door from a user,
wherein the front door is opened after the input is received by the input unit.

3. The image forming apparatus according to claim 2, wherein, while a sheet is being conveyed and stacked on the first stacking portion, the second locking unit prohibits the front door from being opened even if the input unit receives an input for opening the front door.

4. The image forming apparatus according to claim 1, wherein, in a case where a sheet jam occurs in the conveyance path formed by the conveyance guide, the control unit cancels a locked state set by the first locking unit.

5. The image forming apparatus according to claim 1, further comprising a first conveyance path configured to convey a sheet to the first stacking portion,
wherein the conveyance guide constitutes a part of the first conveyance path.

6. The image forming apparatus according to claim 5,
wherein a sheet stacking apparatus includes the first stacking portion, the conveyance guide, the first locking unit, the front door, and the second locking unit,
wherein the sheet stacking apparatus comprises:
the first conveyance path configured to convey a sheet to the first stacking portion; and
a second conveyance path configured to convey a sheet to an apparatus connected to the sheet stacking apparatus,
wherein the first conveyance path has a curved portion, and
wherein the second conveyance path is a straight path.

7. The image forming apparatus according to claim 1,
wherein a sheet stacking apparatus includes the first stacking portion, the conveyance guide, the first locking unit, the front door, and the second locking unit, and
wherein the sheet stacking apparatus comprises a third stacking portion configured to stack a sheet on an upper face of the sheet stacking apparatus.

8. The image forming apparatus according to claim 1, wherein, in a case where a sheet is conveyed to the third stacking portion without passing through the conveyance guide, the control unit allows the front door to be opened by controlling the second locking unit, and prohibits the conveyance guide from being opened by controlling the first locking unit.

9. The image forming apparatus according to claim 1, wherein, in a case where a sheet is conveyed to the first stacking portion, the control unit prohibits the conveyance guide from being opened by controlling the first locking unit.

10. The image forming apparatus according to claim 1,
wherein image forming apparatus comprises:
an operation portion arranged on the conveyance guide, configured to open and close the conveyance guide by being operated by a user; and
an engagement portion integrally rotatable with the operation portion, configured to engage with an engaged portion,
wherein engagement between the engaged portion and the engagement portion is cancelled so that the conveyance guide is opened when the operation portion is rotated in a first direction, and
wherein the first locking unit locks and prohibits the conveyance guide from being opened by regulating rotation of the operation portion in the first direction.

11. The image forming apparatus according to claim 10,
wherein the first locking unit includes a solenoid and a locking member rotated by the solenoid,
wherein the control unit makes the locking member move to a locking position where the locking member abuts on the engagement portion by controlling a power state of the solenoid, and
wherein the locking member located at the locking position regulates rotation of the engagement portion.

12. The image forming apparatus according to claim 1,
wherein the first locking unit includes a solenoid, and
wherein the control unit switches a state of the conveyance guide to a locked state or an unlocked state by controlling a power state of the solenoid.

13. A sheet stacking apparatus comprising:
a first stacking portion configured to stack a sheet;
a conveyance guide configured to form a part of a conveyance path through which a sheet is conveyed, the conveyance guide being openable and closable relative to the conveyance path;
a first locking unit configured to lock the conveyance guide to prohibit the conveyance guide from being opened;
a front door configured to constitute an exterior front face of the sheet stacking apparatus, the front door being closable at a closing position where the front door is closed and being openable at an opening position where the front door is open to expose the first stacking portion and the conveyance guide;
a second locking unit configured to lock the front door to prohibit the front door from being opened; and
a control unit configured to control the first locking unit and the second locking unit,
wherein, in a case where a sheet is conveyed to the first stacking portion, the control unit prohibits the front door from being opened by controlling the second locking unit, and
wherein, in a case where a sheet is conveyed to a second stacking portion different from the first stacking portion after passing through the conveyance guide, the control unit allows the front door to be opened by controlling the second locking unit, and prohibits the conveyance guide from being opened by controlling the first locking unit.

14. An image forming apparatus, comprising:
the sheet stacking apparatus according to claim 13; and
an image forming unit configured to form an image on a sheet stacked on the first stacking portion.
